(19) United States
(12) Patent Application Publication
(10) Pub. No.: US 2008/0314318 A1
(43) Pub. Date: Dec. 25, 2008

(54) Plasma processing apparatus and method thereof

(75) Inventors: Kyung Hyun Han, Suwon-si (KR); Vasily Pashkovskiy, Suwon-si (KR); Doug Yong Sung, Suwon-si (KR); Sang Min Jeong, Seoul (KR); Sang Ho Lee, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 12/081,221

(22) Filed: Apr. 11, 2008

(30) Foreign Application Priority Data
Jun. 20, 2007 (KR) 10-2007-0060206

(51) Int. Cl. H05H 1/00; H05H 1/24

(52) U.S. Cl. 118/723 R; 216/67; 427/569

(57) ABSTRACT

Disclosed is a plasma processing apparatus and a method thereof. A plasma processing apparatus includes a chamber for processing a semiconductor substrate by generating plasma, upper and lower electrodes installed in the chamber, a high frequency power supply for supplying high frequency power to the upper and lower electrodes, and a phase controller adjusting a phase difference of the high frequency power supplied to the upper and lower electrodes.

### CROSS-REFERENCE TO RELATED APPLICATIONS

This application claims the priority benefit of Korean Patent Application No. 2007-0060206, filed on Jun. 20, 2007, in the Korean Intellectual Property Office, the disclosure of which is incorporated herein by reference.

### BACKGROUND

1. Field

Embodiments relate to a plasma processing apparatus and a method thereof. More particularly, embodiments relate to a plasma processing apparatus and a method thereof, capable of improving the process speed and product yield by maximizing density of electrons in plasma and uniformly dispersing the electrons in plasma during a plasma process performed to process a semiconductor substrate using plasma.

2. Description of the Related Art

In general, a plasma processing apparatus is used in the semiconductor manufacturing process to perform etching (or deposition) relative to a semiconductor substrate by using plasma. Among various plasma processing apparatuses, a capacitive coupled plasma (CCP) processing apparatus is mainly used.

The CCP processing apparatus includes a pair of parallel flat plate electrodes (upper and lower electrodes) in a vacuum chamber. Processing gas is introduced into the chamber, and at the same time, radio frequency (hereinafter, referred to as RF) power is applied to one of the electrodes, such that an RF electric field is formed between the electrodes. The gas in the chamber is excited into a plasma state by the RF electric field, so that a plasma etching (or deposition) process is performed on the semiconductor substrate by using ions and electrons generated from the plasma.

Such a plasma processing apparatus employs a high-output RF power supply that supplies RF power to the electrode so as to excite the gas into the plasma state in the chamber. At this time, the frequency and power of the RF power supply may exert an influence upon characteristics of the process.

In the earlier stage, the plasma processing apparatus having a single RF power supply is used. However, as the integration degree of the semiconductor device has been increased, the characteristics required for the semiconductor manufacturing process have been increased. To cope with this situation, methods employing two frequencies have been developed, and recently, the processing apparatuses employing at least three frequencies have been developed.

FIG. 1 shows an RF power supply system of a plasma processing apparatus which employs two frequencies and is disclosed in U.S. Pat. No. 6,423,242.

Referring to FIG. 1, upper and lower electrodes 30 and 50 are located in a chamber 10 in parallel to each other and two RF power supplies 70 and 90 are connected to the upper and lower electrodes 30 and 50, respectively so that two different types of RF power (source RF power and bias RF power) are supplied to the upper and lower electrodes 30 and 50. The RF power having a low frequency adjusts energy of ions among the components of the plasma, whereas the RF power having a high frequency adjusts density of ions to enable a high etch rate (or deposition rate).

In this manner, as the semiconductor manufacturing process requires a higher process speed, the RF power supply system employing two different frequencies must generate a higher density of plasma electrons, so apparatuses employing the higher frequency have been developed. However, the apparatus employing higher frequency causes non-uniformity of the plasma electrons because of a sine wave generated from the electrodes 30 and 50 due to the high frequency. As a result, the etch rate varies according to locations in a wafer when forming a pattern on the wafer.

### SUMMARY

Accordingly, it is an aspect of embodiments to provide to a plasma processing apparatus and a method thereof, capable of improving the process speed and product yield by maximizing density of electrons in plasma and uniformly dispersing the electrons in plasma during a plasma process performed to process a semiconductor substrate using plasma.

In an aspect of embodiments, there is provided a plasma processing apparatus including a chamber to process a semiconductor substrate by generating plasma, upper and lower electrodes installed in the chamber, a high frequency power supply to supply high frequency power to the upper and lower electrodes, and a phase controller to adjust a phase difference of the high frequency power supplied to the upper and lower electrodes.

According to an aspect of embodiments, the phase controller adjusts a density of the plasma or a uniformity of the plasma density.

According to an aspect of embodiments, the plasma processing apparatus further includes a differential phase delay measurement device connected to the upper and lower electrodes to measure a phase difference of the high frequency power generated between the two electrodes.

According to an aspect of embodiments, the phase controller adjusts the phase difference of the high frequency power supplied from the high frequency power supply based on the phase difference of the high frequency power, which is measured by the differential phase delay measurement device, between the upper and lower electrodes.

According to an aspect of embodiments, the plasma processing apparatus further includes a low frequency power supply to supply low frequency power to the upper and lower electrodes.

According to an aspect of embodiments, the low frequency power has a frequency of about 2 MHz to about 13.56 MHz.

According to an aspect of embodiments, the high frequency power has a frequency of about 60 MHz to about 200 MHz.

Further, according to an aspect of embodiments, there is provided a plasma processing apparatus includes a chamber to process a semiconductor substrate by generating plasma, upper and lower electrodes installed in the chamber, a first RF power supply to supply first RF power to the upper and lower electrodes, a first phase controller to adjust a phase difference of the first RF power supplied to the upper and lower electrodes so as to adjust a density of the plasma and a uniformity of the plasma density, a second RF power supply to supply second RF power to the upper and lower electrodes, and a second phase controller to adjust a phase difference of the second RF power supplied to the upper and lower electrodes so as to adjust ion energy of the plasma having a uniform density by the first phase controller.

According to an aspect of embodiments, the first RF power has a relatively high frequency, and the second RF power has a relatively low frequency.

According to an aspect of embodiments, the plasma processing apparatus further includes a differential phase delay measurement device connected to the upper and lower electrodes to measure the phase difference of the first RF power generated between the two electrodes.

According to an aspect of embodiments, the first phase controller adjusts the phase difference of the first RF power supplied from the first RF power supply based on the phase difference of the first RF power, which is measured by the differential phase delay measurement device, between the upper and lower electrodes.

Further, according to an aspect of embodiments, there is provided a plasma processing method includes supplying radio frequency power to upper and lower electrodes installed in a chamber for processing a semiconductor substrate by generating plasma, and adjusting a phase difference of the radio frequency power supplied to the upper and lower electrodes, thereby performing a plasma process.

According to an aspect of embodiments, adjusting a phase difference of the high frequency power supplied to the upper and lower electrodes is performed based on a phase difference of the high frequency power generated between the upper and lower electrodes.

According to an aspect of embodiments, the plasma processing method further includes supplying low frequency power to the upper and lower electrodes.

According to an aspect of embodiments, there is provided a plasma processing method including supplying radio frequency power to upper and lower electrodes installed in a chamber for etching or deposing layers on a semiconductor substrate by generating plasma; and adjusting a phase difference of the radio frequency power supplied to the upper and lower electrodes to perform at least one of etching or deposing layers on the semiconductor substrate.

### BRIEF DESCRIPTION OF THE DRAWINGS

These and/or other aspects, features, and advantages of exemplary embodiments will become apparent and more readily appreciated from the following description of exemplary embodiments, taken in conjunction with the accompanying drawings of which:

FIG. 1 is a view illustrating an RF power supply system of a conventional plasma processing apparatus;

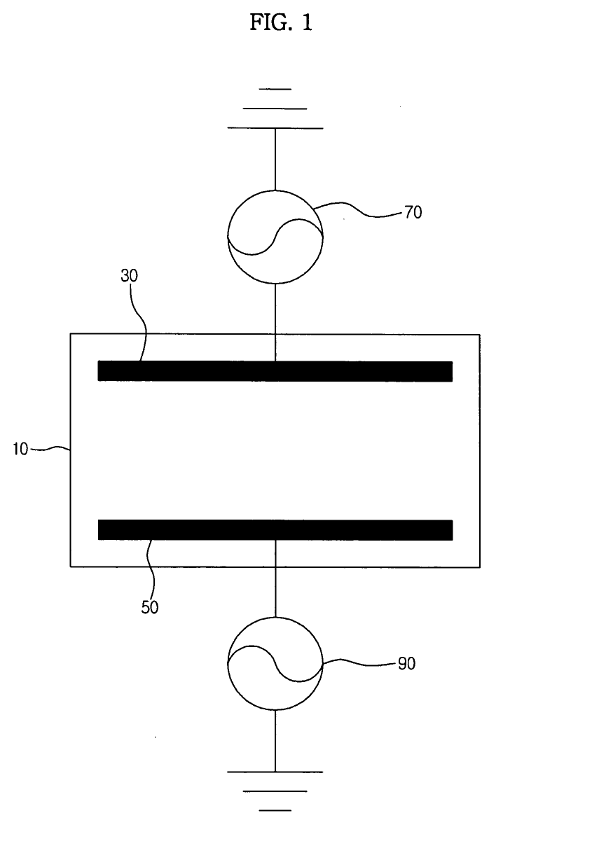

FIG. 2 is a view showing a high frequency/low frequency power supply system of a plasma processing apparatus according to an exemplary embodiment;

FIG. 3 is a flowchart showing a plasma processing method according to an exemplary embodiment; and

FIG. 4 is a graph showing a change of an etch rate in a plasma processing apparatus according to an exemplary embodiment.

### DETAILED DESCRIPTION OF EMBODIMENTS

Reference will now be made in detail to exemplary embodiments, examples of which are illustrated in the accompanying drawings, wherein like reference numerals refer to the like elements throughout. Exemplary embodiments are described below by referring to the figures.

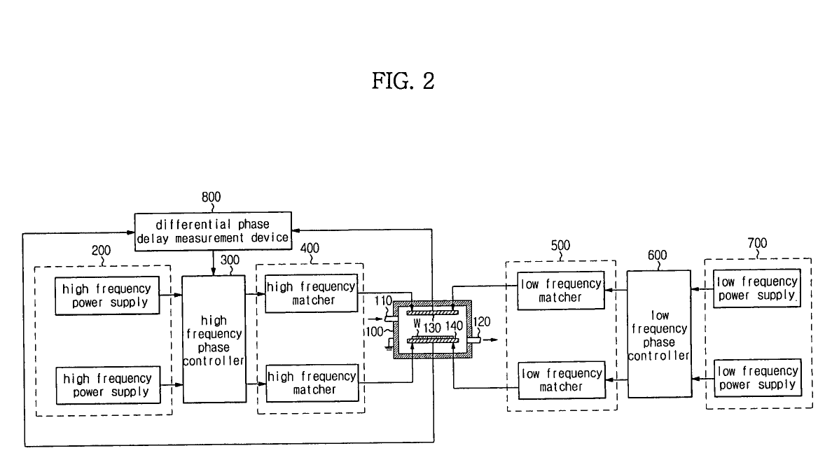

As shown in FIG. 2, a plasma processing apparatus according to an exemplary embodiment includes a chamber 100, a high frequency power supply 200, a high frequency phase controller 300, a high frequency matcher 400, a low frequency matcher 500, a low frequency phase controller 600, a low frequency power supply 700, and a differential phase delay measurement device 800.

The chamber 100 is a process chamber maintained in a vacuum state, in which a semiconductor manufacturing process is performed by using plasma. The chamber 100 has a gas inlet 110 and a gas outlet 120. Gas introduced into the chamber 100 through the gas inlet 110 is excited into a plasma state by high frequency power and low frequency power, such that an etching process is performed on a wafer W, that is, a semiconductor substrate.

An upper electrode 130 faces a lower electrode 140 in the chamber 100, in which the high frequency power and the low frequency power are supplied to the upper electrode 130 and the lower electrode 140.

The upper electrode 130, which is a conductor having the shape of a flat plate, is installed at an upper part of the chamber 100. The upper electrode 130 supplies the high frequency power and the low frequency power to the chamber 100, such that the gas introduced into the chamber 100 is excited into a plasma state.

The lower electrode 140, which is a conductor having the shape of a flat plate, is placed at a lower part of the chamber 100 in parallel to the upper electrode 130. Similar to the upper electrode 130, the lower electrode 140 supplies the high frequency power and the low frequency power to the chamber 100, such that the gas introduced into the chamber 100 is excited into a plasma state, and a target, such as the wafer W, is placed on the lower electrode 140.

The high frequency power supply 200 supplies the high frequency power to the upper and lower electrodes 130 and 140, such that the gas introduced into the chamber 100 is excited into a plasma state. The high frequency power supply 200 supplies power of about 60 MHz to about 200 MHz to the high frequency phase controller 300.

The high frequency phase controller 300 receives the high frequency power from the high frequency power supply 200 so as to adjust the high frequency power to have a predetermined phase difference, and transmits the high frequency power to the upper electrode 130 and the lower electrode 140. The high frequency matcher 400 is connected to the high frequency phase controller 300 for impedance matching to transmit maximum high frequency power to the upper electrode 130 and the lower electrode 140.

The low frequency power supply 700 supplies the low frequency power to the upper and lower electrodes 130 and 140, such that the gas introduced into the chamber 100 is excited into a plasma state, and energy of ions generated from the plasma is adjusted. The low frequency power supply 700 supplies the low frequency power (about 2 MHz to about 13.56 MHz) to the low frequency phase controller 600.

The low frequency phase controller 600 receives the low frequency power from the low frequency power supply 700 so as to adjust the low frequency power to have a predetermined phase difference, and transmits the low frequency power to the upper electrode 130 and the lower electrode 140. The low frequency matcher 500 is connected to the low frequency phase controller 600 for impedance matching to transmit maximum low frequency power to the upper electrode 130 and the lower electrode 140.

The differential phase delay measurement device 800 is connected to the high frequency phase controller 300 so as to measure a phase difference between the high frequency powers output from the upper electrode 130 and the lower electrode 140, and transmit the measured value to the high frequency phase controller 300. The power supplied from the high frequency phase controller 300 has a short vibration period, so that the phase difference thereof changes frequently. However, the distance between the high frequency phase controller 300 and the upper electrode 130 differs from the distance between the high frequency phase controller 300 and the lower electrode 140, so that the high frequency power arrives at the electrodes with time difference. As a result, the high frequency power deviating from the predetermined phase difference is supplied. Accordingly, it is preferable to take the time difference of the high frequency power arrived at the electrodes into consideration.

The high frequency phase controller 300 adjusts the predetermined phase difference of the high frequency power again, and generates a phase difference, which is required by a user, between two electrodes so as to supply the high frequency power to the upper and lower electrodes 130 and 140 by taking into consideration the phase difference of the high frequency power transmitted from the differential phase delay measurement device 800.

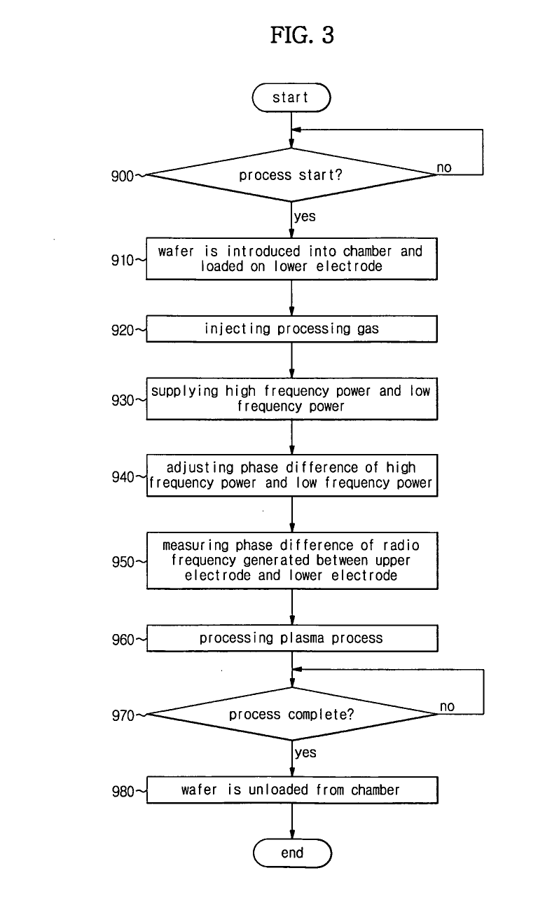

FIG. 3 is a flowchart showing a plasma processing method according to an exemplary embodiment, in which one wafer is processed through the plasma processing method using plasma.

Referring to FIG. 3, when a process starts (900), the wafer W to be processed is introduced into the chamber 100 and loaded on the lower electrode 140 (910).

At this time, processing gas supplied from a gas supply (not shown) is injected into the chamber 100 through the gas inlet 110 until the pressure of the process is appropriate (920).

After injecting the gas into the chamber 100 (920), the high frequency power (60 MHz to 200 MHz) supplied from the high frequency power supply 200 is supplied to the high frequency phase controller 300, and at the same time, the low frequency power (2 MHz to about 13.56 MHz) supplied from the low frequency power supply 700 is supplied to the low frequency phase controller 600 (930).

The high frequency phase controller 300 supplies the high frequency power to the upper electrode 130 and the lower electrode 140 through the high frequency matcher 400 with a time delay such that the high frequency power can be provided to the upper electrode 130 and the lower electrode 140 with a predetermined phase difference. Thus, the gas injected into the chamber 100 is excited into a plasma state, and the density of the plasma in the chamber 100 becomes uniform. At the same time, the low frequency phase controller 600 also supplies the low frequency power to the upper electrode 130 and the lower electrode 140 through the low frequency matcher 500 with a time delay such that the low frequency power can be provided to the upper electrode 130 and the lower electrode 140 with a predetermined phase difference. Thus, the plasma is introduced into the wafer loaded on the lower electrode 140, such that a plasma process is started (940). According to the plasma process, an etching and deposition process is performed on layers of the wafer by using the ions and electrons released from the plasma.

When the high frequency power is supplied to the upper electrode 130 and the lower electrode 140, the differential phase delay measurement device 800 measures a phase difference of the high frequency power between two electrodes, and transmits the measured value to the high frequency phase controller 300. The high frequency phase controller 300 adjusts the predetermined phase difference of the high frequency power according to the phase difference of the high frequency power transmitted from the differential phase delay measurement device 800, and transmits the high frequency power to the upper and lower electrodes 130 and 140 such that the phase difference can be set between two electrodes as required by the user (950).

In this manner, the density of the electrons in the plasma is maximized by minimizing the loss of the electrons in the plasma, and at the same time, the density of the electrons in the plasma is uniform, so that the plasma process is stably performed during the given time (960).

After that, when the process is completed (970), the wafer W is unloaded from the chamber 100, so that the process for the wafer W ends (980).

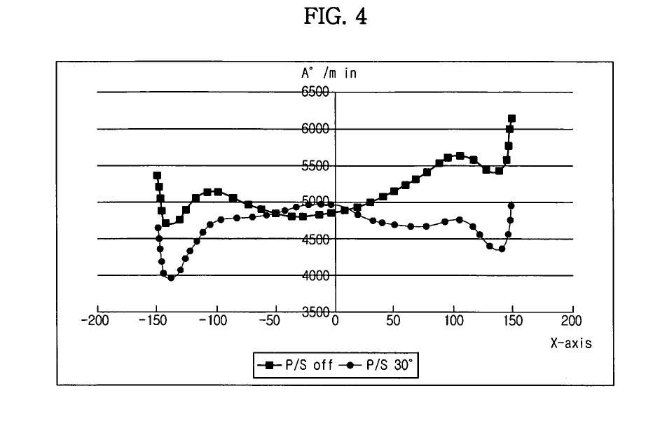

FIG. 4 is a graph showing a change of an etch rate in a plasma processing apparatus according to an exemplary embodiment. FIG. 4 shows the change of the etch rate before and after controlling the phase difference.

As shown in FIG. 4, when the high frequency powers having the same phase are applied to the upper electrode 130 and the lower electrode 140, the density of the plasma is non-uniform between the upper electrode 130 and the lower electrode 140, so that the etch rate is not high. However, if the phase of the high frequency powers applied to the upper electrode 130 and the lower electrode 140 is adjusted, the etch rate is increased.

As described above, a plasma processing apparatus according to an exemplary embodiment adjusts the phase difference of the high frequency power by taking into consideration the phase difference, which is caused when the high frequency power is applied to the upper and lower electrodes in the chamber. As a result, the density of electrons in plasma is uniformly maintained. Accordingly, the process speed and product yield of the semiconductor process is improved.

Although few exemplary embodiments have been shown and described, it would be appreciated by those skilled in the art that changes may be made in these exemplary embodiments, the scope of which is defined in the claims and their equivalents.

What is claimed is:

1. A plasma processing apparatus comprising:
a chamber to process a semiconductor substrate by generating plasma;
upper and lower electrodes installed in the chamber;
a high frequency power supply to supply high frequency power to the upper and lower electrodes; and
a phase controller to adjust a phase difference of the high frequency power supplied to the upper and lower electrodes.

2. The plasma processing apparatus of claim 1, wherein the phase controller adjusts a density of the plasma.

3. The plasma processing apparatus of claim 1, further comprising a differential phase delay measurement device connected to the upper and lower electrodes to measure a phase difference of the high frequency power generated between the two electrodes.

4. The plasma processing apparatus of claim 3, wherein the phase controller adjusts the phase difference of the high frequency power supplied from the high frequency power supply based on the phase difference of the high frequency power, which is measured by the differential phase delay measurement device, between the upper and lower electrodes.

5. The plasma processing apparatus of claim 1, further comprising a low frequency power supply to supply low frequency power to the upper and lower electrodes.

6. The plasma processing apparatus of claim 5, wherein the low frequency power has a frequency of about 2 MHz to about 13.56 MHz.

7. The plasma processing apparatus of claim 1, wherein the high frequency power has a frequency of about 60 MHz to about 200 MHz.

8. A plasma processing apparatus comprising:
a chamber to process a semiconductor substrate by generating plasma;
upper and lower electrodes installed in the chamber;
a first RF power supply to supply first RF power to the upper and lower electrodes;
a first phase controller to adjust a phase difference of the first RF power supplied to the upper and lower electrodes so as to adjust a density of the plasma and a uniformity of the plasma density;
a second RF power supply to supply second RF power to the upper and lower electrodes; and
a second phase controller to adjust a phase difference of the second RF power supplied to the upper and lower electrodes so as to adjust ion energy of the plasma having a uniform density by the first phase controller.

9. The plasma processing apparatus of claim 8, wherein the first RF power has a relatively high frequency, and the second RF power has a relatively low frequency.

10. The plasma processing apparatus of claim 9, wherein the high frequency power has a frequency of about 60 MHz to about 200 MHz, and the low frequency power has a frequency of about 2 MHz to about 13.56 MHz.

11. The plasma processing apparatus of claim 8, further comprising a differential phase delay measurement device connected to the upper and lower electrodes to measure a phase difference of the first RF power generated between the two electrodes.

12. The plasma processing apparatus of claim 11, wherein the first phase controller adjusts the phase difference of the first RF power supplied from the first RF power supply based on the phase difference of the first RF power, which is measured by the differential phase delay measurement device, between the upper and lower electrodes.

13. A plasma processing method comprising:
supplying radio frequency power to upper and lower electrodes installed in a chamber for processing a semiconductor substrate by generating plasma; and
adjusting a phase difference of the radio frequency power supplied to the upper and lower electrodes, thereby performing a plasma process.

14. The method of claim 13, wherein adjusting the phase difference of the high frequency power supplied to the upper and lower electrodes is performed based on the phase difference of the high frequency power generated between the upper and lower electrodes.

15. The method of claim 13, further comprising supplying low frequency power to the upper and lower electrodes.

16. The method of claim 15, wherein the low frequency power has a frequency of about 2 MHz to about 13.56 MHz.

17. The method of claim 13, wherein the high frequency power has a frequency of about 60 MHz to about 200 MHz.

18. The plasma processing apparatus of claim 1, wherein the phase controller adjusts a uniformity of the plasma density.

19. The method of claim 13, wherein adjusting the phase difference adjusts a density of the plasma.

20. The method of claim 13, wherein adjusting the phase difference adjusts a uniformity of the plasma density.

21. A plasma processing method comprising:
supplying radio frequency power to upper and lower electrodes installed in a chamber for etching or deposing layers on a semiconductor substrate by generating plasma; and
adjusting a phase difference of the radio frequency power supplied to the upper and lower electrodes to perform at least one of etching or deposing layers on the semiconductor substrate.

22. The method of claim 21, wherein adjusting the phase difference adjusts a density of the plasma.

23. The method of claim 21, wherein adjusting the phase difference adjusts a uniformity of the plasma density.
